(19) United States
(12) Patent Application Publication
(10) Pub. No.: US 2020/0298675 A1
(43) Pub. Date: Sep. 24, 2020

(54) VEHICLE SIDE VISOR

(71) Applicant: Haim Amram BEN-SIMHON, HAIFA (IL)

(72) Inventor: Haim Amram BEN-SIMHON, HAIFA (IL)

(21) Appl. No.: 15/856,135

(22) Filed: Dec. 28, 2017

(30) Foreign Application Priority Data
Nov. 16, 2017 (IL) 255719

(51) Int. Cl. B60J 3/02

(52) U.S. Cl. CPC B60J 3/0204

(57) ABSTRACT

The present invention relates to vehicle accessories. Currently available vehicles, for example automobiles, cars, trucks and the like comprise a front visor configured to shade the driver and/or a passenger sitting in a front seat and protect them against dazzling light, for example sun rays.

### FIELD OF THE INVENTION

The present invention relates to vehicle accessories. More particularly, the present invention relates to vehicle visors.

### BACKGROUND OF THE INVENTION

Currently available vehicles, for example automobiles, cars, trucks and the like comprise a front visor configured to shade the driver and/or a passenger sitting in a front seat and protect them against dazzling light, for example sun rays. A prior art front visor is illustrated in FIG. 1.

FIG. 1 schematically illustrates, according to an exemplary embodiment, a partial perspective view of a car cabin 20. Just for illustration, some components of a prior art car cabin are shown in FIG. 1: a steering wheel 100, a windshield 200, a side door 300, a side window 400, a front mirror 500, a side mirror 600 and a front visor 700. The front visor 700 comprises an opaque screen 702 pivotally attached to a longitudinal axis 704, and a turning axis 706 to which an end of the longitudinal axis 704 is attached, while the turning axis 706 is attached normally to an upper windshield 200 frame. The front visor 700 illustrated in FIG. 1 is installed in front of the driver and is configured to shade the driver and protect him against dazzling sun rays. A similar front visor 700 may be installed also in front a passenger's seat aside the driver's seat.

The screen 702 of the visor 700 may be turned about the longitudinal axis 702 upwards and downwards, and be fixed in a desired position. When the driver and/or passenger sitting aside the driver is not dazzled by light, the screen 702 of the visor 700 may be turned upwards, for example in order not to disturb the field of vision. When the driver and/or the passenger sitting aside the driver is dazzled by light coming from the front, he may turn the screen 702 in front of him downwards and fix the screen 702 in a position where it blocks the light and eliminate dazzling. In cases where light irradiates at the side of the driver, through the side window 400, the longitudinal axis 704, with the screen 702 attached to it, may be turned about the turning axis 706 and fixed in a position aside the side window 400 in order to block the light and eliminate dazzling. Thus, the prior art front visor 700 is configured to block dazzling by light irradiating at the front as well at the side of the driver and/or a passenger sitting aside the driver.

A drawback of the prior art front visor 700 is that changing its position from a front position to a side position is normally done during driving, sometimes at high speeds. This may be dangerous when the driver is forced to change the position of the front visor 700 from a front position to a side position, and vice versa, during driving, since this distracts the driver's attention during driving. The problem is more prominent with non-experienced drivers or old drivers.

For example, a driver drives a car from east to west while the sun is in front of his eyes, just before sunset. In order to eliminate dazzling, the screen 702 of the front visor 700 is fixed in front of the driver. Then, the driver has to turn right to the direction of south to north, for example at a speed of 30-70 km/hour, in order to merge with a highway. In order to eliminate dazzling by the sun that during the turning is changing position to the side window 400, the driver has to turn the front visor 700 aside and turn the screen 702 downwards. However, this activity may distract the driver's attention during the sensitive maneuver of merging with a highway, and he may avoid turning the screen 702 of the front visor 700 aside. However, by doing so the driver may be dazzled by the sun during the merging with the highway, thus putting him in high risk since he may not be able to clearly notice the vehicles on the highway, or even the highway itself.

Therefore, a major drawback of prior art front visors is that drivers prefer to be dazzled instead of bothering themselves with changing the position of the front visor 700 during driving, especially in sensitive occasions that require full attention of the driver, as well as the ability to get a clear picture of the vehicle's surrounding.

### SUMMARY OF THE INVENTION

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

According to one aspect of the present subject matter there is provided a vehicle side visor configured to block light irradiating at a side of a vehicle, the vehicle side visor comprising: a side screen configured to block light irradiation, pivotally attached to a side longitudinal axis allowing turning of the side screen upward and downward, the side longitudinal axis attached to a part of the vehicle positioned at a side of the vehicle.

According to one embodiment, the side longitudinal axis is pivotally attached to the part of the vehicle positioned at the side of the vehicle.

According to another embodiment, the side longitudinal axis is fixed to the part of the vehicle positioned at the side of the vehicle.

According to a further embodiment, the part of the vehicle positioned at the side of the vehicle is a frame of a side window.

According to yet a further embodiment, the part of the vehicle positioned at the side of the vehicle is a part of the vehicle's body.

According to another aspect of the present subject matter there is provided an independent side vehicle window antiglare visor having back and front attachments, the front attachment allows the visor to be rotated up or down and alternately side to front, and the visor is activated by removing the visor from a housing and rotating the visor frontwardly, thus exposing a handle positioned underneath.

According to one embodiment, identical visors are attached to a frame of a back door's window.

### BRIEF DESCRIPTION OF THE DRAWINGS

Embodiments are herein described, by way of example only, with reference to the accompanying drawings. With specific reference now to the drawings in detail, it is stressed that the particulars shown are by way of example and for purposes of illustrative discussion of the preferred embodiments, and are presented in the cause of providing what is believed to be the most useful and readily understood description of the principles and conceptual aspects of the embodiments. In this regard, no attempt is made to show structural details in more detail than is necessary for a fundamental understanding, the description taken with the drawings making apparent to those skilled in the art how several forms may be embodied in practice.

In the drawings:

FIG. 1 schematically illustrates, according to an exemplary embodiment, a partial perspective view of a car cabin 20.

FIG. 2 schematically illustrates, according to an exemplary embodiment, a vehicle side visor comprising a side longitudinal axis fixed to a part of a vehicle positioned aside a driver or a passenger sitting in the vehicle.

### DESCRIPTION OF THE PREFERRED EMBODIMENTS

Before explaining at least one embodiment in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting. In discussion of the various figures described herein below, like numbers refer to like parts. The drawings are generally not to scale.

For clarity, non-essential elements were omitted from some of the drawings.

The present subject matter provides a vehicle side visor 1 configured to block light illuminating at a side of a vehicle. According to one embodiment, the vehicle side visor is configured to block light irradiating at a right side of the vehicle. According to another embodiment, the vehicle side visor is configured to block light irradiating at a left side of the vehicle. According to yet another embodiment, the vehicle side visor is configured to block light irradiating at a back side of the vehicle. According to still another embodiment, the vehicle side visor is configured to block light irradiating at any side of the vehicle except the front side of the vehicle.

According to one embodiment, the vehicle side visor 1 comprises a side screen 12 configured to block light irradiation, for example sun irradiation, lamp light irradiation and the like. Thus, the side screen 12 is opaque, or partially opaque. The side screen 12 is pivotally attached to a side longitudinal axis 14, allowing turning of the side screen 12 upward and downward, and the side longitudinal axis 14 is attached to a part of a vehicle positioned at a side of a vehicle, for example at a right side, a left side or a back side of a vehicle. According to another embodiment, the side longitudinal axis is attached to any side of the vehicle except the front side of the vehicle. According to another embodiment, the side longitudinal axis is attached to any side of the vehicle except the front side of the vehicle

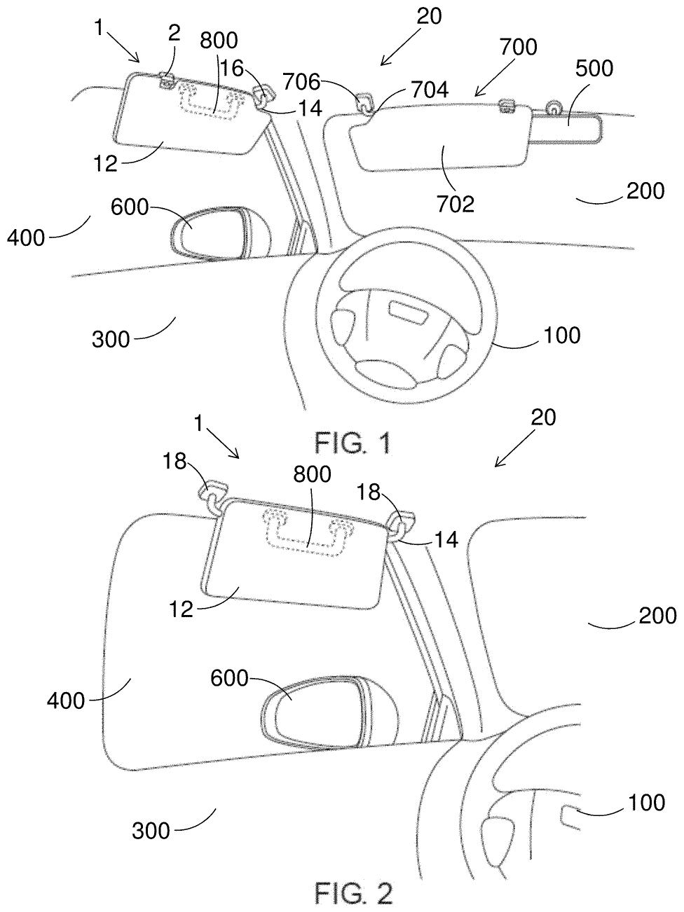

According to one embodiment, the side longitudinal axis 14 of the vehicle side visor 1 is pivotally attached to a part of a vehicle positioned at a side of the vehicle. According to this embodiment, as can be seen in FIG. 1, an end of the side longitudinal axis 14 is attached to a side turning axis 16 that is attached to a part of a vehicle positioned aside a driver or a passenger sitting in the vehicle. According to this embodiment, the side longitudinal axis 14 is configured to turn about the side turning axis 16, and thus either be positioned aside a driver or a passenger, or in front of a driver or a passenger.

FIG. 2 schematically illustrates, according to an exemplary embodiment, a vehicle side visor comprising a side longitudinal axis fixed to a part of a vehicle positioned aside a driver or a passenger sitting in the vehicle. According to another embodiment, illustrated in FIG. 2, the side longitudinal axis 14 of the vehicle side visor is attached to a part of the vehicle positioned at a side of the vehicle, in a fixed manner. Any means known in the art for fixing the side longitudinal axis 14 to a part of a vehicle positioned aside a driver or a passenger sitting in the vehicle is under the scope of the present subject matter. As illustrated in FIG. 2, the vehicle side visor 1 further comprises at least one, preferably two, attaching elements 18 that fix the side longitudinal axis 14 to a part of a vehicle positioned aside a driver or a passenger sitting in the vehicle.

According to one embodiment, the part of a vehicle positioned aside a driver or a passenger sitting in the vehicle, to which the side longitudinal axis 14 is attached, is a frame of the side window 400. In other words, according to this embodiment, the vehicle side visor 1 is attached to the side door 300 of the vehicle. According to another embodiment, the part to which the side longitudinal axis 14 is attached is a part of the vehicle's body, just under the roof of the vehicle. According to this embodiment, the vehicle side visor 1 is attached to the vehicle body.

As can be seen in FIGS. 1 and 2, the vehicle further comprises a handle 800 attached above the side window 400. According to one embodiment, the vehicle side visor 1 is configured to block light irradiation from the side while not being interfered by the handle 800. Thus, when the side screen 12 is turned downwards it covers the handle, illustrated in FIGS. 1 and 2 with dashed lines.

According to one embodiment, as can be seen in FIG. 1, the vehicle side visor 1 further comprises a housing 2 attached to the upper frame of the door of the vehicle. The housing 2 is receptive to the side screen 12. When a driver desires to expose the handle 800, he removes the side screen 12 from the housing 2 and rotates the side screen frontwardly utilizing the side turning axis 16, thus exposing the handle 800 to be held by the driver, and helps the driver in standing and going out of the vehicle.

### Additional Arguments and Description

Existing car has a windshield sun visor, that by rotating the visor downwards, it forms a barrier from the glaring sun rays, when the sun is in front of the face of the driver.

At times the sun will glare the driver from the side door window. In that case the windshield sun visor is rotated first downwards then laterally to protect from the sun that glares through the side window. That is, the existing sun visor serves both against the sun which glares from the front, and alternately the glare that comes from the side door window. That is the visor interchanges from front to side door and vice versa.

The problem is that the changing of position has to be done while driving, sometimes at a speed of 40-70 km/hour. The frontal sun visor has to be taken out of the housing in front of the upper frame of the windshield, then rotates downwards and then laterally to the side door window. To protect from the rays that coming from the side door window.

This takes the attention from driving and could be dangerous, especially for new drivers and elderly drivers. (that is why the drivers avoid changing the position). Note, that the change is needed when drivers simultaneously and turning from the sun in front to the position wereas the sun glare comes from the side window.

For example, one is driving from east to west while the sun is in front of his face (just before sunset). Now, he has to turn to the right to the direction of south to north at the speed 30-70 km/hour to merge with the highway. The changing of the visor downwards and then side way bring the visor in front of the face of the driver and interferes with the proper view of the turning road in front of him.

I believe it is cumbersome and disturbing every driver.

I drove on the highway from south to north during sunset time and noticed that 95% of the drivers do not utilizes this option of the conventional front windshield visor and therefore are glared. I simply counted hundred cars who bypassed me (I drove relatively slow so the drivers could bypassed me) and I could see if the windshield visor was utilized to the side door (west) window. I counted hundred cars, and I found that only 5 drivers used the option to rotate laterally front windshield visor.

### Purpose of the Invention

To eliminate the need of multiple moves rotation (two) of the front visor to the side. (left in the case of the driver). The idea is to construct a special side-window visor on the upper frame of the door. Thus the visor could be activated by single rotation downwards of the sun visor.

### DISCLOSURE

A visor similar to the front windshield visor and with same attachments is constructed on the upper panel of the frame of the side door. Thus one rotation (without disturbing the vision of the driver) activates the protection from the glare. Basically, the same as in the windshield front window, when it is activated to protect from glare from the front.

The same visors could be constructed for the other side windows of the car.

The invention is side windows visor that could be activated independently from the frontal windshield visor. Namely the car will have two or more independent sun visor one for the front windshield and one for the side door window.

Optional additional visors could be attached to the other three or more side windows. In some cars, in the upper frame of the window there is a handle to help lift up yourself. To use it simply rotates the sun window visor frontwards and exposes the handle. This can be done easily because the handle is used only when the car standing (stalling). one never needs it while driving.

Following are aspects of the invention that may be claimed:
I. Independent side window antiglare visor that is activated by single downwards move rotation.
II. Independent visor for back windows mounted on upper inner frame of the doors.
III. Independent visor(s) to be mounted on existing cars on the upper front frame of the door (s) of the cars and means to attached visor(s) to said frames.
IV. Motorized visors for the car: front visor, and side visor(s).
V. An independent side vehicle window antiglare visor having back and front attachments, the front attachment allows the visor to be rotated up or down and alternately side to front, and the visor is activated by removing the visor from a housing and rotating the visor frontwardly, thus exposing a handle positioned underneath.
VI. The independent side vehicle window antiglare visor of claim 6, wherein identical visors are attached to a frame of a back door's window.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1. A vehicle side visor configured to block light irradiating at a side of a vehicle, the vehicle side visor comprising:
a side screen configured to block light irradiation, pivotally attached to a side longitudinal pivot allowing turning of the side screen upward and downward, the side longitudinal pivot attached to a part of the vehicle positioned at a side of the vehicle; and
a holder attached to the side wall configured to hold an end of the visor, the end towards a rear of the vehicle, when the visor is not in use, wherein the holder mates with an upper edge of the visor such that the removing of the visor from the holder is accomplished by a single simple downward motion,
wherein the side longitudinal pivot is pivotally attached to the part of the vehicle positioned at the side of the vehicle or fixed to the part of the vehicle positioned at the side of the vehicle.

2.-3. (canceled)

4. The vehicle side visor of claim 1, wherein the part of the vehicle positioned at the side of the vehicle is a frame of a side window.

5. The vehicle side visor of claim 1, wherein the part of the vehicle positioned at the side of the vehicle is a part of the vehicle's body.

6. An apparatus for preventing glare through a side window of a vehicle, comprising:
an independent side vehicle window antiglare visor,
a handle attached to an upper frame of a side window or to a side wall of the vehicle above the side window, the visor configured to cover the handle when the visor is not in use;
the visor having a front attachments and a back attachment, wherein the front attachment is configured to allow the visor to be rotated up or down on a side longitudinal pivot and is configured to alternately rotate from side to front,
a holder attached to the side wall configured to hold an end of the visor, the end towards a rear of the vehicle, when the visor is not in use and the visor is activated by removing the visor from the housing and rotating the visor frontwardly, thus exposing the handle positioned underneath.

7. The independent side vehicle window antiglare visor of claim 6, wherein identical visors are attached to frames of each of back doors windows of the vehicle.

8. The vehicle side visor of claim 2, wherein the part of the vehicle positioned at the side of the vehicle is a frame of a side window.

9. The vehicle side visor of claim 3, wherein the part of the vehicle positioned at the side of the vehicle is a frame of a side window.

10. The vehicle side visor of claim 2, wherein the part of the vehicle positioned at the side of the vehicle is a part of the vehicle's body.

11. The vehicle side visor of claim 3, wherein the part of the vehicle positioned at the side of the vehicle is a part of the vehicle's body.

12. The vehicle side visor of claim 1, wherein the side longitudinal pivot is operatively connected to a motor so as to control the upward and downward motions.

13. The vehicle side visor of claim 6, wherein the side longitudinal pivot is operatively connected to a motor so as to control the up and down rotations.

14. An apparatus for preventing glare through a side window of a vehicle, comprising:
an independent side vehicle window antiglare visor,
the visor configured to be attached to an upper portion of a side wall of the vehicle above the side window,
the visor having a front attachment configured to allow the visor to be rotated up or down on a horizontal pivot element and is configured to alternately rotate from a side of the vehicle interior to a front of the vehicle interior to prevent glare through a front window of the vehicle,
a holder attached to the side wall configured to hold an end of the visor that faces a rear of the vehicle, wherein when the visor is not in use and the visor is activated by, in a single motion, removing the visor from the housing and rotating the visor frontwardly, thus exposing the handle positioned underneath.

15. The apparatus of claim 14, wherein the up and down rotations are actuated using a motor connected to the visor.

16. The apparatus of claim 14, wherein the holder mates with an upper edge of the visor such that the removing of the visor from the holder is accomplished by a single simple downward motion.

17. The apparatus of claim 16, wherein the up and down rotations and the alternately side to front motions are actuated using a motor connected to the visor.

18. The apparatus of claim 14, wherein the holder mates with an upper edge of the visor at other than an upper distal corner of the visor such that the upper distal corner of the visor is free for a user, in substantially a single motion, to grab the upper distal corner, releases the visor from the holder and swing the visor around to the front of the interior of the vehicle.

19. The apparatus of claim 14, wherein the horizontal pivot element is pivotally attached to the side of the vehicle or is fixed to a part of the vehicle positioned at the side of the vehicle.

20. The apparatus of claim 14, further comprising an independent visor for a back window mounted on an upper inner frame of a back door of the vehicle, the visor configured to allow the visor to be rotated up or down on a horizontal pivot element.
